(19) United States
(12) Patent Application Publication
(10) Pub. No.: US 2009/0153393 A1
(43) Pub. Date: Jun. 18, 2009

(54) OBSTACLE DETECTING CONTROL DEVICE OF VEHICLE

(75) Inventor: Kenichi IKEDA, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/143,203

(22) Filed: Jun. 20, 2008

(30) Foreign Application Priority Data
Jul. 18, 2007 (JP) 2007-186910

(51) Int. Cl. G01S 13/93

(52) U.S. Cl. 342/70

(57) ABSTRACT

A control device controls operational devices based on obstacle-detection state detected by the radar device and controls a radar-waves transmitting portion of the obstacle detecting device based on detection of a vehicle speed sensor. The control device is configured to control the radar-waves transmitting portion so that a ratio of transmission term of radar waves transmitted to plural transmission areas is changeable in accordance with detection of the vehicle speed. Accordingly, any obstacle present in any transmission area can be detected promptly and surely.

### BACKGROUND OF THE INVENTION

The present invention relates to an obstacle detecting control device of a vehicle that comprises an obstacle detecting device to detect an obstacle in front of the vehicle.

Conventionally, a radar device, which detects an obstacle by transmitting radar waves forward and then receiving radar waves reflected on the obstacle, is well known. Some type of such radar device can change a detection area, which is disclosed in Japanese Patent Laid-Open Publication No. 7-129900, for example.

An electronic scanning type of radar device has been recently developed. In this radar device the detectable distance is changeable by changing the scanning angle of radar waves transmitted, so that the radar waves can be transmitted to plural transmission areas selectively. That is, the plural transmission areas of radar waves have different values of a distance between its vehicle-presence position and its front tip position. Thus, by changing the scanning angle of radar waves, the radar waves can be transmitted to a near transmission area having a relatively short distance and a far transmission area having a relatively long distance selectively, for example. Herein, due to the difference in the scanning angle, the width of the near transmission area is relatively narrow, while the width of the far transmission area is relatively wide.

Thus, using the radar device capable to send the radar waves to plural transmission areas selectively makes it easy to select the transmission area according to vehicle traveling state or the like. For example, in case the vehicle traveling speed is faster than a specified speed, it is preferably selected that the radar waves be transmitted to a far transmission area, so that any obstacle that is present far away can be properly detected. Meanwhile, in case the vehicle traveling speed is slower than the specified speed, it is preferably selected that the radar waves be transmitted to a near transmission area, so that any obstacle that is present near can be properly detected. Accordingly, any obstacle is detected so promptly and surely by selecting the transmission area of radar waves according to the vehicle traveling speed that an operational device, such as a brake, can be operated properly against the detected obstacle.

However, the above-described selection control may be insufficient. For example, when the vehicle is traveling at the high speed with the far transmission area selected, another obstacle could possibly emerge rapidly in the near transmission area. In this case, since the radar waves are transmitted only to the far transmission area, there is a concern that the detection of any obstacle emerging in the near transmission area would be delayed improperly.

### SUMMARY OF THE INVENTION

The present invention has been devised in view of the above-described problem, and an object of the present invention is to provide an obstacle detecting control device of a vehicle that can detect any obstacle promptly and surely regardless of where it is present, thereby properly controlling any operational device.

According to the present invention, there is provided an obstacle detecting control device of a vehicle, comprising an obstacle detecting device to detect an obstacle in front of the vehicle, the obstacle detecting device comprising a radar-waves transmitting portion to transmit radar waves forward and a radar-waves receiving portion to receive radar waves reflected on the obstacle, the radar-waves transmitting portion being configured to transmit the radar waves to plural transmission areas selectively, a detecting device to detect a traveling state of the vehicle and/or a condition of a road on which the vehicle travels, and a control device operative to control an operational device of the vehicle based on obstacle-detection state detected by the obstacle detecting device and control the radar-waves transmitting portion of the obstacle detecting device based on detection of the detecting device, wherein the control device is configured to control the radar-waves transmitting portion so that a ratio of transmission term of the radar waves transmitted to the plural transmission areas is changeable in accordance with the detection of the detecting device.

According to the above-described present invention, the control device controls the radar-waves transmitting portion of the obstacle detecting device based on detection of the detecting device so that the ratio of transmission term of the radar waves transmitted to the plural transmission areas is changeable in accordance with the traveling state of the vehicle (vehicle traveling speed, etc.) and/or the condition of the road on which the vehicle travels (road width, presence of pedestrian, etc.). For example, in case the plural transmission areas have a different detectable distance from each other and they are comprised of a near transmission area and a far transmission area, when the vehicle traveling speed is faster than a specified speed, the transmission-term ratio of the radar waves transmitted to the far transmission area is changed so as to become larger than that of the radar waves transmitted to the near transmission area. Meanwhile, when the vehicle traveling speed is the specified speed or slower, the transmission-term ratio of the radar waves transmitted to the near transmission area is changed so as to become larger than that of the radar waves transmitted to the far transmission area. Accordingly, the transmission-term ratio of the radar waves transmitted to the far transmission area that is properly selected according to the vehicle traveling state or the road condition, so that any obstacle that is present in any transmission area can be detected promptly and surely. Herein, the radar waves are transmitted to any transmittable area, so that any obstacle emerging in any area can be detected. Thus, any necessary action against any obstacle detected can be achieved with the operational device.

According to an embodiment of the present invention, the plural transmission areas have a different detectable distance from each other.

Further, according to another embodiment of the present invention, the plural transmission areas comprise two areas of a near transmission area and a far transmission area, or three areas of a near transmission area, a middle transmission area, and a far transmission area.

According to the above-described embodiments, any obstacle can be detected promptly and surely in case it is present far from or near to the traveling vehicle. Particularly, in case the transmission-term ratio of the radar waves transmitted to the far transmission area or the middle transmission area is set to be relatively large, even if another obstacle emerges rapidly in the near transmission area, the operational device, such as brake, can be properly operated against the obstacle having emerged.

According to another embodiment of the present invention, the detecting device comprises a traveling-speed detecting device to detect a vehicle traveling speed, and the control device is configured to control the radar-waves transmitting portion so that the transmission-term ratio of the radar waves transmitted to the plural transmission areas is changeable in accordance with the vehicle starveling speed detected by the traveling-speed detecting device.

Thereby, the transmission-term ratio of the radar waves transmitted to the specified transmission area that may be appropriate to the current vehicle traveling speed can be made large, so that any obstacle in that area can be detected promptly and surely. Specifically, it is preferable that the control device be configured to control the radar-waves transmitting portion so that the transmission-term ratio of the radar waves transmitted to the plural transmission areas is changeable in accordance with the vehicle starveling speed detected by the traveling-speed detecting device in such a manner that the transmission-term ratio of the radar waves transmitted to the near transmission area becomes large compared with that to the far transmission area when the vehicle traveling speed is relatively slow.

According to another embodiment of the present invention, the detecting device comprises a road-width detecting device to detect a width of the road on which the vehicle travels, and the control device is configured to control the radar-waves transmitting portion so that the transmission-term ratio of the radar waves transmitted to the plural transmission areas is changeable in accordance with the road width detected by the road-width detecting device.

Thereby, the transmission-term ratio of the radar waves transmitted to the specified transmission area that may be appropriate to the current width of the road on the vehicle travels can be made large, so that any obstacle in that area can be detected promptly and surely. Specifically, it is preferable that the control device be configured to control the radar-waves transmitting portion so that the transmission-term ratio of the radar waves transmitted to the plural transmission areas is changeable in accordance with the road width detected by the road-width detecting device in such a manner that the transmission-term ratio of the radar waves transmitted to the near transmission area becomes large compared with that to the far transmission area when the road width is relatively narrow. Thus, since the possibility of obstacle's rapid emergence in the near area is higher in case the vehicle traveling on the relatively narrow road, such obstacle can be detected promptly and surely with the above-described setting of the transmission-term ratio of the radar waves.

According to another embodiment of the present invention, the detecting device comprises a pedestrian detecting device to detect a pedestrian on the road, and the control device is configured to control the radar-waves transmitting portion so that the transmission-term ratio of the radar waves transmitted to the plural transmission areas is changeable in accordance with the pedestrian detected by the pedestrian detecting device.

Specifically, it is preferable that the control device be configured to control the radar-waves transmitting portion so that the transmission-term ratio of the radar waves transmitted to the plural transmission areas is changeable in accordance with the pedestrian detected by the pedestrian detecting device in such a manner that the transmission-term ratio of the radar waves transmitted to a specified transmission area that corresponds to a location where the detected pedestrian is present is larger than that to other transmission area. Further, in case it is detected that plural pedestrians are present in the plural areas of the transmission areas, the transmission-term ratios of the millimeter waves transmitted to the respective transmission areas may be changed in accordance with the number ratio of present pedestrians. Thereby, since the transmission-term ratio of the radar waves transmitted to the specified transmission area that may have higher possibility of the detected pedestrian coming in is made properly large, such pedestrian (obstacle) can be detected promptly and surely.

According to another embodiment of the present invention, the operational device of the vehicle controlled by the control device comprises at least one of a brake operating device to operate brake of the vehicle and a seatbelt pre-tensioner to restrain a passenger with application of a specified tension to a seatbelt by winding up the seatbelt. Thereby, any proper action against any obstacle detected can be properly achieved with the brake operating device and/or the seatbelt pre-tensioner.

Other features, aspects, and advantages of the present invention will become apparent from the following description which refers to the accompanying drawings.

### BRIEF DESCRIPTION OF THE DRAWINGS

FIG. 1 is a diagram of a front portion of a vehicle equipped with an obstacle detecting control device according to a first embodiment of the present invention.

FIG. 2 is a block diagram showing the obstacle detecting control device.

FIG. 3 is a plan view showing respective locations of transmission areas.

FIG. 4 is a flowchart showing control processing of an operational device by a control unit.

FIG. 5 is a chart showing a relationship between a transmission-term ratio and a vehicle speed.

FIG. 6 is a flowchart showing a millimeter-wave transmission control processing by the control unit.

FIG. 7 is a block diagram showing a second embodiment, which corresponds to FIG. 2.

FIG. 8 is a chart showing a relationship between a transmission-term ratio and a road width.

FIG. 9 is a block diagram showing a third embodiment, which corresponds to FIG. 2.

### DETAILED DESCRIPTION OF TIE INVENTION

Hereinafter, preferred embodiments of the present invention will be described referring to the accompanying drawings.

### Embodiment 1

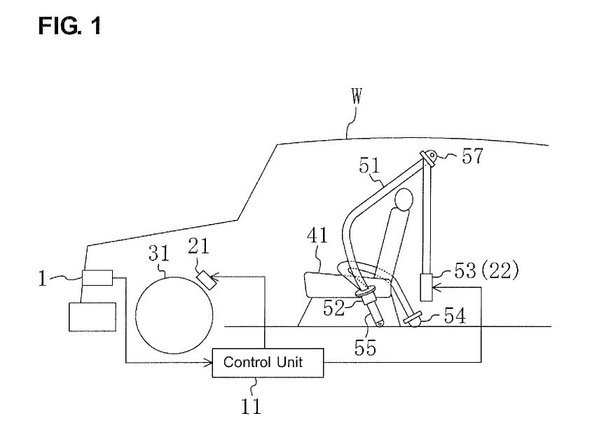

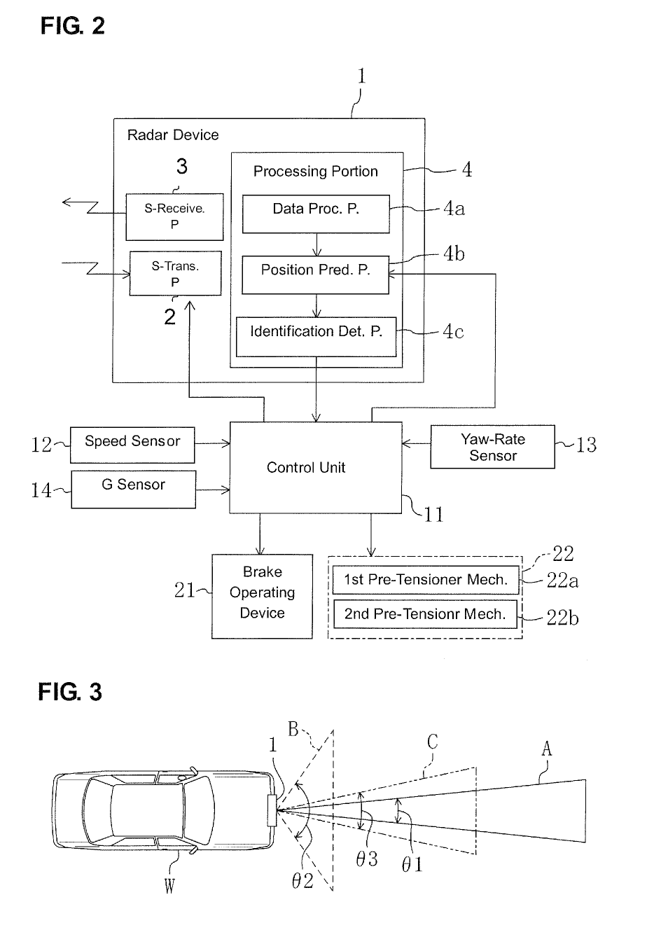

FIG. 1 shows a vehicle W (a traveling vehicle as an automotive vehicle in the present embodiment) that is equipped with an obstacle detecting control device according to a first embodiment of the present invention. A radar device 1, as an obstacle detecting device, operative to detect an obstacle that may exist in front of the vehicle W is provided at a front end portion of the vehicle W. The radar device 1 is an electronic scanning type of millimeter-wave radar device, which comprises, as shown in FIG. 2, a signal-transmitting portion 2, as a radar-waves transmitting portion, which transmits millimeter waves (radar waves) forward, scanning a specified-angled area in a substantially horizontal direction, a signal-receiving portion 3, as a radar-waves receiving portion, which receives millimeter waves reflected on any obstacle in front of the vehicle W, and a processing portion 4 that performs the following obstacle-detection processing based on data received by the signal-receiving portion 3.

The signal-transmitting portion 2 is configured to transmit the millimeter waves to plural transmission areas selectively. In the present embodiment, the above-described specified-angled area for scanning (scanning angle) is comprised of three areas of small (θ1), middle (θ3) and large (θ2). Thus, the millimeter waves can be transmitted to these three areas selectively (the millimeter waves are transmittable further with the smaller scanning angle). Each area of three transmission areas has a substantially isosceles triangle shape, as shown in FIG. 3, so that the width of each area becomes wider gradually from the front end of the vehicle W. Thus, these areas have respective scanning angles and different detectable distances from each other. Specifically, a transmission area (shown by solid lines) shows a far transmission area A that has a small scanning angle θ1 and a long detectable distance, a transmission area (shown by broken lines) shows a near transmission area B that has a large scanning angle θ2 and a short detectable distance, and a transmission area (shown by two-dotted broken lines) shows a middle transmission area C that has a middle scanning angle θ3 and a middle detectable distance. Herein, the respective detectable distances may be set about 100 m, 10 m, and 50 m, for example.

Herein, the respective areas are overlapped partially as shown.

The vehicle W is also equipped with a control unit 11 that performs an operational-device control function for controlling some operational devices of the vehicle W based on obstacle-detection information from the processing portion 4 of the radar device 1. Herein, the operational devices include a brake operating device 21 and a seatbelt pre-tensioner 22.

The vehicle W also comprises, as shown in FIG. 2, a vehicle speed sensor 12 as a traveling-speed detecting device to detect a traveling speed of the vehicle W, a yaw-rate sensor 13 to detect a yaw rate generating at the vehicle W, and a G sensor 4 to detect hitting of the vehicle W against the obstacle. Detection information of these sensors 12-14 are inputted to the control unit 11.

The brake operating device 21 operates brake of the vehicle W to apply a braking force to vehicle wheels 31. The seatbelt pre-tensioner 22 operates to restrain a passenger seated in a seat 41 of the vehicle W with application of a specified tension to a seatbelt 51 by winding up the seatbelt 51.

Hereinafter, a seatbelt device of the vehicle W will be described. The seatbelt device is a three-point type of seatbelt, as shown in FIG. 1, that comprises a retractor portion 53 to wind up the seatbelt 51, a lap anchor portion 54 to which a tip of the seatbelt 51 withdrawn from the retractor 53 is connected, a buckle portion 55 to which a tongue 52 provided at a central portion of the seatbelt 51 is detachably connected. The buckle portion 55 is fixed to a vehicle body beside the seat 41, and the retractor 53 and the lap anchor portion 54 are fixed to the vehicle body on its opposite side of the seat 41. The seatbelt 51 withdrawn from the retractor portion 53 is changed from upward to downward in its withdrawal direction by a slip guide 57 provided at an upper portion of the seat 41, and its tip end is attached to the lap anchor portion 54. The above-described tongue 52 is provided to move over the seatbelt 51 between the slip guide 57 and the lap anchor portion 54. The seatbelt 51 is set by engaging the tongue 52 with the buckle portion 55.

The seatbelt pre-tensioner 22 is provided in the retractor portion 53 of the above-described seatbelt device. The seatbelt pre-tensioner 22 of the present embodiment comprises, as shown in FIG. 2, a first pre-tensioner mechanism 22a, in which the seatbelt 51 is wound up by an electric motor or the like, and a second pre-tensioner mechanism 22b, in which the seatbelt 51 is wound up with a force of gas generated by an inflator. When the hitting of the vehicle W against the obstacle is predicted (for example, a predicted time of hitting is shorter than a predetermined standard time) based on the obstacle detecting information supplied from the processing portion 4 of the radar device 1, the above-described control unit 11 operates the first pre-tensioner mechanism 22a to apply a specified tension to the seatbelt 51. Meanwhile, when the hitting of the vehicle W against the obstacle is detected by the G sensor 14, the control unit 11 operates the second pre-tensioner mechanism 22b to apply to the seatbelt 51 a greater tension than the specified tension by the first pre-tensioner mechanism 22a.

The control unit 11 also determines a turning radius of the traveling vehicle W based on detections of the vehicle speed sensor 12 and the yaw-rate sensor 13. Specifically, the turning radius R may be obtained from the following equation with the vehicle speed V and the yaw rate φ:

R=V/φ

Herein, there may be further provided a lateral acceleration sensor to detect an lateral acceleration of the vehicle W or a steering angle sensor to detect a steering angle of a steering wheel of the vehicle W, and a detection of either one of these sensors may be used in place of the detection of the yaw-rate sensor 13 to determine the turning radius of the traveling vehicle W.

The processing portion 4 of the radar device 1 comprises, as shown in FIG. 2, a data processing portion 4a, a position predicting portion 4b, and an identification determining portion 4c. Herein, the data processing portion 4a detects the obstacle by conducting a filter processing, FFT processing and the like, for the data received by the signal-receiving portion 3. The position predicting portion 4b receives the data from the data processing portion 4a and the vehicle speed and the turning radius of the vehicle W from the control unit 11, and then based on these data predicts a position of the obstacle detected after a specified time (corresponding to the scanning term of millimeter waves) has passed. The identification determining portion 4c makes a determination as to whether or not the obstacle that is detected at the above-described specified time passage is identical to the above-described obstacle whose position has been predicted based on the above-described predicted position by the position predicting portion 4b. Specifically, a determination area surrounding this predicted position with a specified distance from this predicted position is set, and if the obstacle detected at the above-described specified time passage is located within this determination area, it is determined that the obstacle is identical to the obstacle whose position has been predicted. Meanwhile, if the obstacle detected at the above-described specified time passage is located outside the determination area, it is determined that the obstacle is a new obstacle that is different from the one whose position has been predicted. Thus, the identification determining portion 4c transmits data of the detected obstacle (the distance between the obstacle and the vehicle W, the relative direction to the vehicle W, the direction and value of the relative speed, etc.) to the control unit 11 as an obstacle detection data.

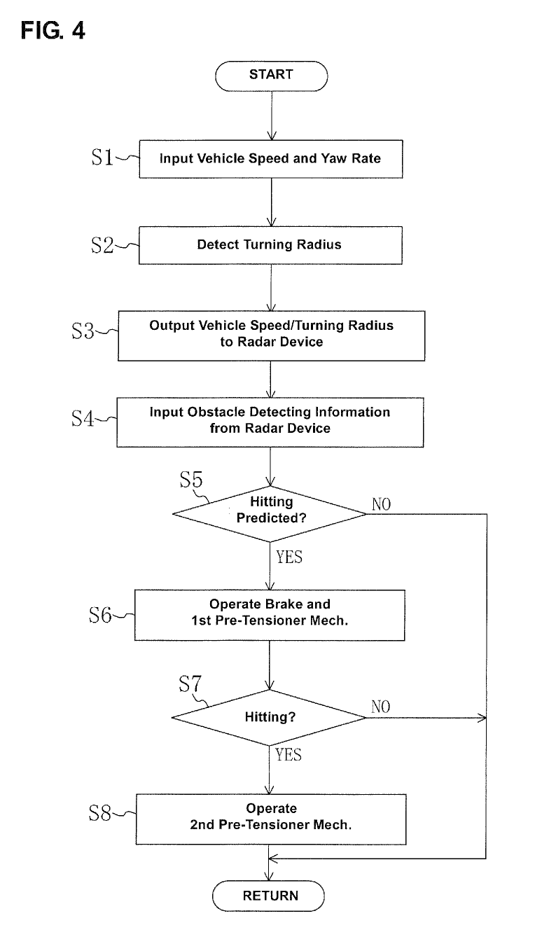

Hereinafter, processing operations of the operational devices (the brake operating device 21 and the seatbelt pre-tensioner 22) by the control unit 11 will be described referring to a flowchart of FIG. 4.

First, in step S1, the vehicle speed and the yaw rate that are respectively detected by the vehicle speed sensor 12 and the yaw-rate sensor 13 are inputted. Then, the turning radius of the traveling vehicle W is detected based on the vehicle speed and the yaw rate in step S2. Next, in step S3, the vehicle speed and turning radius are outputted to the position prediction portion 4b of the processing portion 4 of the radar device 1.

In step S4, the obstacle detecting information from the identification determining portion 4c of the processing portion 4 of the radar device 1 is inputted. It is determined based on the inputted obstacle detecting information whether the vehicle W hitting the obstacle is predicted or not in step S5.

When the determination is NO in the step S5, the control sequence returns. When it is YES, the control sequence proceeds to step S6, where the brake operating device 21 is operated to apply the brake to the respective wheels 31 and the first pre-tensioner mechanism 22a of the seatbelt pre-tensioner 22 is operated to apply the specified tension to the seatbelt 51.

Next, in step S7, it is determined based on the information from the G sensor 14 whether the vehicle W hits the obstacle or not. When the determination is NO in the step S7, the control sequence returns. When it is YES, the control sequence proceeds to step S8, where the second pre-tensioner mechanism 22b of the seatbelt pre-tensioner 22 is operated to apply the greater tension to the seatbelt 51, and then the control sequence returns.

The control device 11 controls the signal transmitting portion 2 so as to transmit the millimeter waves to the above-described three transmission areas (the far transmission area A, near transmission area B, and the middle transmission area C) with specified ratios of transmission term of the millimeter waves within a specified time. Further, the control device is configured so that the above-described specified ratios of transmission term are changeable in accordance with the vehicle traveling state. In the present embodiment, the traveling speed of the vehicle W (vehicle speed) is detected by the vehicle speed sensor 12 as the traveling state of the vehicle W, and the specified transmission-term ratios are changed by the vehicle speed detected. Thus, the control unit 11 performs a radar-waves transmission control function for changing the transmission-term ratio in accordance with the vehicle traveling state, and the vehicle speed sensor 12 (the traveling-speed detecting device) detects the vehicle traveling state.

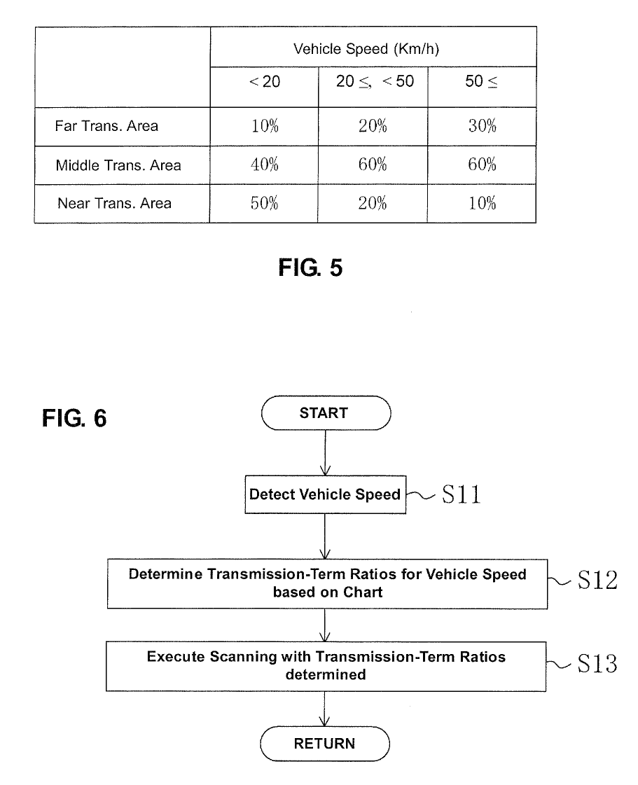

A relationship between the above-described specified transmission-term ratios and the vehicle speed are stored in the control unit 11 in a chart shown in FIG. 5. It is set, as shown in this chart, so that as the vehicle speed becomes slower, the transmission-term ratio of the millimeter waves transmitted to the far transmission area A becomes smaller, while the transmission-term ratio of the millimeter waves transmitted to the near transmission area B becomes larger.

It may be preferable that the above-describe specified time be set so that at least one time of scanning (going and coming back) can be conducted to any transmission area. For example, if the specified time is ten times as long as the time per scanning and the vehicle speed is less than 10 km/h in the example shown in FIG. 5, the millimeter-waves scanning to the far transmission area A can be conducted once (at one time) within the specified time. And, within this specified time, four times of scanning may be possible for the middle transmission area C, and five times of scanning may be possible for the near transmission area B. Therein, this scanning with plural times for the respective transmission areas A, B, C are executed separately, not continuously for each area. However, the continuous scanning for each area may be possible in case the specified time is sufficiently short.

Hereinafter, a millimeter-waves transition control processing operation of the control unit 11 will be described referring to a flowchart of FIG. 6.

At first, in step S11, the vehicle speed sensor 12 detects the vehicle speed. Then, in step S12, the transmission-term ratio of the millimeter waves of the respective transmission areas A, B, C that corresponds to the vehicle speed detected is determined based on the chart. In the next step S13, the scanning of the millimeter waves with the transmission-tern ratio determined are executed.

According to the millimeter-waves transition control processing operation of the control unit 11, when the vehicle speed is 50 km/h or higher, the millimeter waves are transmitted to the far transmission area A and the middle transmission area C preponderantly. As a result, any obstacle present in these areas A, C can be detected promptly and surely. Meanwhile, some millimeter waves are transmitted to the middle transmission area B. accordingly, even if another obstacle has emerged rapidly in the near transmission area B, such obstacle can be also detected promptly. Particularly, since the width of the near transmission area B is wider than those of the other areas A, C, this detection of the obstacle emerging in the near transmission area B can be achieved properly. Thus, the brake operating device 21 and the like can be operated against that obstacle as well.

Further, as the vehicle speed becomes slower, the transmission-term ratio of the millimeter waves transmitted to the far transmission area A becomes smaller, while the transmission-term ratio of the millimeter waves transmitted to the near transmission area B becomes larger. The detection of any obstacle that is present near the vehicle W can be improved. Then, when the vehicle speed is loser than 20 km/h, although the transmission-term ratio of the millimeter waves transmitted to the near transmission area B becomes large, the transmission of some millimeter waves to the far transmission area A is maintained. The detection of the obstacle emerging in the far transmission area A can be achieved properly.

Although the traveling speed of the vehicle W is detected as the traveling state of the vehicle W in the above-described embodiment 1, the turning radius of the vehicle W, which can be determined by detection values of the vehicle speed sensor 12 and the yaw-rate sensor 13 for example, may be detected as the vehicle traveling state. Thus, the above-described transmission-term ratio of the millimeter waves may be changed in accordance with the turning radius of the vehicle W. In this case, it may be preferable that as the turning radius becomes greater, the transmission-term ratio of the millimeter waves transmitted to the far transmission area A become smaller, while the transmission-term ratio of the millimeter waves transmitted to the near transmission area B become larger.

### Embodiment 2

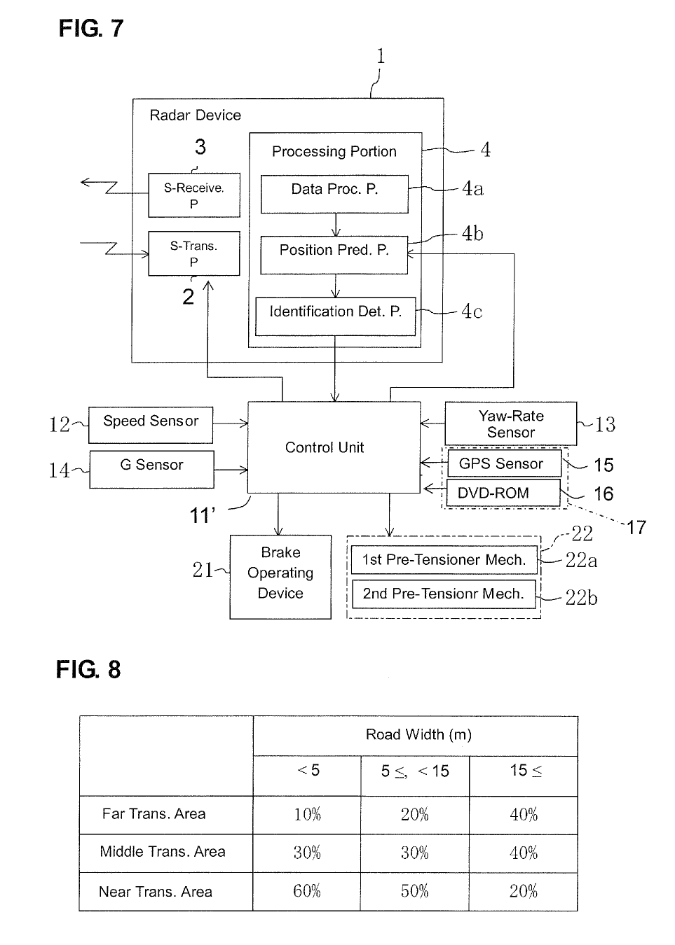

FIG. 7 shows a second embodiment of the present invention, which comprises a GPS sensor 15 to detect a present location of the vehicle W and a DVD-ROM 16 to store information of road map (including the road width) in addition to the first embodiment 1. The other hardware structures are the same as those of the first embodiment, whose description is omitted here. Herein, the GPS sensor 15 and the DVD-ROM 16 are part of a navigation device 17, a control portion of which performs the navigation function based on the current location information of the vehicle W detected by the GPS sensor 15 and the road map information stored in the DVD-ROM 16.

In the present embodiment, a control unit 11′ receives information from the GPS sensor 15 and the DVD-ROM sensor 16, and detects the width of the road on which the vehicle W travels at this moment based on the information. And, it changes the transmission-term ratio of the millimeter waves transmitted to the respective transmission areas A, B, C in accordance with the road width detected. Thus, the GPS sensor 15 and the DVD-ROM sensor 16 constitute a road-width detecting device to detect the width of the road on which the vehicle W travels at this moment and a detecting device to detect the condition of the road on which the vehicle W travels at this moment.

A relationship between the above-described specified transmission-term ratios and the road width are stored in the control unit 11′ in a chart shown in FIG. 8, like the first embodiment 1. It is set, as shown in this chart, so that as the road width becomes narrower, the transmission-term ratio of the millimeter waves transmitted to the far transmission area A becomes smaller, while the transmission-term ratio of the millimeter waves transmitted to the near transmission area B becomes larger.

And, the road width using the GPS sensor 15 and the DVD-ROM sensor 16 detects the road width, the transmission-term ratio of the millimeter waves of the respective transmission areas A, B, C that corresponds to the road width detected is determined based on the chart, and the scanning of the millimeter waves with the transmission-term ratio determined are executed.

According to the present embodiment, when the road width is 15 m or wider, the millimeter waves are transmitted to the far transmission area A and the middle transmission area C preponderantly. As a result, any obstacle present in these areas A, C can be detected promptly and surely. Meanwhile, some millimeter waves are transmitted to the middle transmission area B. Accordingly, even if another obstacle has emerged rapidly in the near transmission area B, such obstacle can be also detected promptly.

Further, as the road width becomes narrower, the transmission-term ratio of the millimeter waves transmitted to the far transmission area A becomes smaller, while the transmission-term ratio of the millimeter waves transmitted to the near transmission area B becomes larger. The detection of any obstacle that is present near the vehicle W can be improved. That is, since the possibility of the obstacle's rapid emergence in the near area is higher in case of the narrow road width, such obstacle can be detected promptly and surely with the above-described setting of the transmission-term ratio of the millimeter waves. Then, when the road width is narrower than 5 m, since the transmission-term ratio of the millimeter waves transmitted to the near transmission area B becomes the largest, the detection of the obstacle emerging in the near transmission area B can be achieved properly. Also, since some millimeter waves are transmitted to the far transmission area A, even if another obstacle emerges in the far transmission area A, such obstacle can be detected promptly.

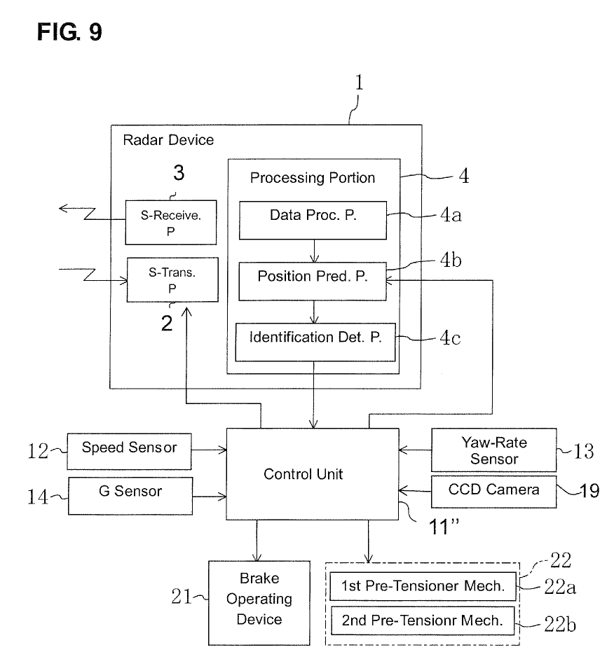

Although the width of the road on which the vehicle W travels is detected based on the information from the GPS sensor 15 and the DVD-ROM sensor 16 in the above-described embodiment 2, it may be detected by a CCD camera 19, which is described below, (see FIG. 9) of a third embodiment.

### Embodiment 3

FIG. 9 shows a third embodiment of the present invention, which comprises a CCD camera 19 to take images in front of the vehicle W in addition to the first embodiment 1. The other hardware structures are the same as those of the first embodiment, whose description is omitted here.

Image data from the CCD camera 19 is inputted to the control unit 11″, and the control unit 11″ detects any pedestrian that is present on the road on which the vehicle W travels outside the transmission areas A, B, C (such as, on a side walk or an edge of the road) and the distance from the vehicle W to the pedestrian. Thus, the pedestrian, specifically, existence of the pedestrian and the distance to the pedestrian are detected as the road condition of the traveling vehicle W. The existence of the pedestrian may be determined based taken images compared with a human's contour, and the distance between the pedestrian and the vehicle W may be determined based on a pedestrian's vertical position in the image taken. Herein, the control unit 11″ is configured so that the transmission-term ratio of the millimeter waves transmitted to the transmission areas A, B, C is changeable in accordance with the pedestrian detected, specifically the distance between the pedestrian and the vehicle W. Thus, the CCD camera 19 constitutes a pedestrian detecting device and a detecting device to detect the condition of the road on which the vehicle W travels at this moment.

For example, in case the detected distance shows that the pedestrian detected is present in the far transmission area B, the transmission-term ratio of the millimeter waves transmitted to the near transmission area B is changed to be larger than that to the other areas A, C. Further, in case it is detected that plural pedestrians are present in the plural areas of the transmission areas A, B, C, the transmission-term ratios of the millimeter waves transmitted to the respective transmission areas are changed in accordance with the number ratio of present pedestrians.

Thus, according to the present embodiment, since the transmission-term ratio of the millimeter waves transmitted to the specified transmission area that may have higher possibility of the detected pedestrian coming in is made properly high, such pedestrian can be detected promptly and surely. Also, since some millimeter waves are transmitted to the other transmission area, even if another obstacle emerges in that area, such obstacle can be detected promptly.

The above-described embodiments 1, 2 and 3 show that the transmission-term ratio of the millimeter waves transmitted to the transmission areas A, B, C is changed in accordance with either one of the traveling speed of the vehicle W, the width of the road on which the vehicle W travels, and the distance between the pedestrian and the vehicle W, which are detected. However, the transmission-term ratio may be changed in accordance with combination of plural detections of those. Further, this changing may be executed with the order of priority. For example, when it is detected that the pedestrian is present on the road on which the vehicle W travels outside the transmission areas A, B, C, the transmission-term ratio may be changed in accordance with the distance between the pedestrian and the vehicle W. Meanwhile, when it is detected that no pedestrian is present, the transmission-term ratio may be changed in accordance with the vehicle traveling speed and/or the road width.

Also, the plural transmission areas may be comprised of two areas of a near transmission area (with a relatively-short detectable distance) and a far transmission area (with a relatively-long detectable distance), instead of three areas A, B, C, or may be comprised of four areas of more.

In this case, it is preferable that the detectable distance of the above-described near transmission area be set to be longer than that of the area B, while the detectable distance of the above-described far transmission area be set to be shorter than that of the area A. Also, for example, in case the vehicle starveling speed (or the road width) is higher than the specified value, the transmission-term ratio of the millimeter waves transmitted to the far transmission area is set to be larger than that to the near transmission area. Meanwhile, in case the vehicle starveling speed (or the road width) is the specified value or lower, the transmission-term ratio of the millimeter waves transmitted to the near transmission area is set to be larger than that to the far transmission area.

Further, the plural transmission area may be formed to be located side by side in the vehicle width direction, without being overlapped, unlike the above-described areas A, B, C. In this case, the areas may have the same detectable distance or different one from each other (e.g., the center-located area may have a longer detectable distance than that of both-side located areas). And, the transmission-term ratio of the millimeter waves transmitted to the transmission areas is changed in accordance with a turning radius of the vehicle W in such a manner that the transmission-term ratio of the millimeter waves transmitted to a transmission area that is located on a tuning-toward side becomes great compared with that to another transmission area that is on its opposite side when the turning radius of the vehicle W is relatively large.

Also, any other type of radar device than the electronic scanning type of millimeter-waves radar device may be applied as long as the radar waves (any type of radar waves) are transmittable to plural transmission areas selectively. For example, a radar device that transmits the radar waves with a mechanical scanning.

Further, any operational device other than the brake operating device 21 or the seatbelt pre-tensioner 22, such as a warning device, may be applied.

Thus, the present invention should not be limited to the above-described embodiments, and any other modifications and improvements may be applied within the scope of a sprit of the present invention.

What is claimed is:

1. An obstacle detecting control device of a vehicle, comprising:
an obstacle detecting device to detect an obstacle in front of the vehicle, the obstacle detecting device comprising a radar-waves transmitting portion to transmit radar waves forward and a radar-waves receiving portion to receive radar waves reflected on the obstacle, the radar-waves transmitting portion being configured to transmit the radar waves to plural transmission areas selectively;
a detecting device to detect a traveling state of the vehicle and/or a condition of a road on which the vehicle travels; and
a control device operative to control an operational device of the vehicle based on obstacle-detection state detected by the obstacle detecting device and control the radar-waves transmitting portion of the obstacle detecting device based on detection of the detecting device,
wherein the control device is configured to control the radar-waves transmitting portion so that a ratio of transmission term of the radar waves transmitted to the plural transmission areas is changeable in accordance with the detection of the detecting device.

2. The obstacle detecting control device of a vehicle of claim 1, wherein said plural transmission areas have a different detectable distance from each other.

3. The obstacle detecting control device of a vehicle of claim 2, wherein said plural transmission areas comprise two areas of a near transmission area and a far transmission area, or three areas of a near transmission area, a middle transmission area, and a far transmission area.

4. The obstacle detecting control device of a vehicle of claim 1, wherein said detecting device comprises a traveling-speed detecting device to detect a vehicle traveling speed, and said control device is configured to control the radar-waves transmitting portion so that the transmission-term ratio of the radar waves transmitted to the plural transmission areas is changeable in accordance with the vehicle starveling speed detected by the traveling-speed detecting device.

5. The obstacle detecting control device of a vehicle of claim 4, wherein the control device is configured to control the radar-waves transmitting portion so that the transmission-term ratio of the radar waves transmitted to the plural transmission areas is changeable in accordance with the vehicle traveling speed detected by the traveling-speed detecting device in such a manner that the transmission-term ratio of the radar waves transmitted to a near transmission area becomes large compared with that to a far transmission area when the vehicle traveling speed is relatively slow.

6. The obstacle detecting control device of a vehicle of claim 1, wherein said detecting device comprises a road-width detecting device to detect a width of the road on which the vehicle travels, and said control device is configured to control the radar-waves transmitting portion so that the transmission-term ratio of the radar waves transmitted to the plural transmission areas is changeable in accordance with the road width detected by the road-width detecting device.

7. The obstacle detecting control device of a vehicle of claim 6, wherein the control device is configured to control the radar-waves transmitting portion so that the transmission-term ratio of the radar waves transmitted to the plural transmission areas is changeable in accordance with the road width detected by the road-width detecting device in such a manner that the transmission-term ratio of the radar waves transmitted to a near transmission area becomes large compared with that to a far transmission area when the road width is relatively narrow.

8. The obstacle detecting control device of a vehicle of claim 1, wherein said detecting device comprises a pedestrian detecting device to detect a pedestrian on the road, and said control device is configured to control the radar-waves transmitting portion so that the transmission-term ratio of the radar waves transmitted to the plural transmission areas is changeable in accordance with the pedestrian detected by the pedestrian detecting device.

9. The obstacle detecting control device of a vehicle of claim 8, wherein the control device is configured to control the radar-waves transmitting portion so that the transmission-term ratio of the radar waves transmitted to the plural transmission areas is changeable in accordance with the pedestrian detected by the pedestrian detecting device in such a manner that the transmission-term ratio of the radar waves transmitted to a specified transmission area that corresponds to a location where the detected pedestrian is present is larger than that to other transmission area.

10. The obstacle detecting control device of a vehicle of claim 1, wherein the operational device of the vehicle controlled by said control device comprises at least one of a brake operating device to operate brake of the vehicle and is a seatbelt pre-tensioner to restrain a passenger with application of a specified tension to a seatbelt by winding up the seatbelt.
